(19) United States
(12) Patent Application Publication
(10) Pub. No.: US 2026/0126677 A1
(43) Pub. Date: May 7, 2026

(54) OPTICAL SOURCES INCLUDING HEATING ELEMENTS AND OPTICAL WAVEGUIDES AND RELATED PHOTONIC INTEGRATED CIRCUIT DEVICES

(71) Applicant: The Government of the United States of America, as represented by the Secretary of the Navy, Arlington, VA (US)

(72) Inventors: Marcel W. Pruessner, Chevy Chase, MD (US); Steven T. Lipkowitz, Potomac, MD (US); Jacob N. Bouchard, Alexandria, VA (US); Nathan F. Tyndall, Alexandria, VA (US); Todd H. Stievater, Arlington, VA (US)

(73) Assignee: The Government of the United States of America, as represented by the Secretary of the Navy, Arlington, VA (US)

(21) Appl. No.: 19/361,138

(22) Filed: Oct. 17, 2025

Related U.S. Application Data
(60) Provisional application No. 63/715,678, filed on Nov. 4, 2024.

(51) Int. Cl. G02F 1/01; G02F 1/015

(52) U.S. Cl. CPC G02F 1/0147; G02F 1/0102; G02F 1/0115; G02F 1/0155

(57) ABSTRACT

According to some embodiments of the present disclosure, an optical source includes a substrate, a dielectric support layer, an electrically conductive heating element, and an optical waveguide. The dielectric support layer is on a surface of the substrate, and the dielectric support layer includes a dielectric material. The electrically conductive heating element is on the dielectric support layer. The optical waveguide is on the dielectric support layer, and the optical waveguide includes a waveguide material different than the dielectric material of the dielectric support layer. Related photonic integrated circuit (PIC) devices are also disclosed.

### CROSS-REFERENCE

This Application is a Nonprovisional Utility Patent Application and claims the benefit of priority under 35 U.S.C. Sec. 119 based on U.S. Provisional Patent Application No. 63/715,678 filed on Nov. 4, 2024. The disclosures of Provisional Application No. 63/715,678 and all references cited herein are hereby incorporated in their entirety by reference into the present disclosure.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #212402.

### TECHNICAL FIELD

The present disclosure relates generally to optics, and more particularly to optical sources and related photonic integrated circuit devices.

### BACKGROUND

Photonic integrated circuits (PICs) may provide large-scale combination of many photonic components on a chip-scale platform. This integration is enabled by silicon photonic foundries with wafer-scale (up to 300 mm diameter, see Reference [1]) fabrication capabilities using state-of-the-art CMOS tools. While the majority of photonic components, e.g. waveguides, delay lines, optical cavity filters, and modulators, are now available from foundries (see References [2] and [3]) via process design kits (PDKs) (see References [1], [2], and [4]), on-chip integrated optical sources are still lacking. A variety of methods to integrate silicon and silicon nitride (SiN) PICs with direct bandgap materials suitable for lasing or amplification have been proposed (see References [5] and [7]). However, all of these methods may generally require substantial, experimental modifications to existing foundry processes, often increasing cost and/or decreasing yield. In addition, on-chip laser-based sources tend to focus on specific narrow optical bands, and may be unsuitable for broadband applications such as sensing or component verification.

Chemical sensors enabled by optical waveguide absorption spectroscopy (see References [8] and [9]) rely on changes in the loss spectrum in the presence of chemical analytes over a broad wavelength range without requiring a narrow linewidth optical source. While on-chip detection of small-molecule gases has been demonstrated using off-chip lasers (see Reference [10]), inexpensive and monolithically integrated broadband optical sources in the near-infrared may be useful to enable true sensor systems-on-a chip. Additionally, a variety of gases including NH₃, CO₂, CO and NO exhibit rich absorption spectra in the 1-10 μm range (see Reference [11]) making thermal sources ideal for absorption spectroscopy. Although chip-scale surface-normal thermal emitters have previously been demonstrated (see References [12]-[17]), few emitters have been coupled to on-chip waveguides (see References [18]-[21]).

A foundry-integrated broadband near-infrared optical source based on hot carriers in a silicon (Si) p-i-n waveguide was demonstrated in Reference at wavelengths λ_{≈}^{>} 1100 nm (limited by band edge absorption in the Si waveguide).

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, an optical source includes a substrate, a dielectric support layer, an electrically conductive heating element, and an optical waveguide. The dielectric support layer is on a surface of the substrate, and the dielectric support layer comprises a dielectric material. The electrically conductive heating element is on the dielectric support layer. The optical waveguide is on the dielectric support layer, and the optical waveguide comprises a waveguide material different than the dielectric material of the dielectric support layer.

According to some other embodiments of inventive concepts, a photonic integrated circuit (PIC) device includes an optical source, power supply circuitry, and a photonic component. The optical source includes a substrate, a dielectric support layer, an electrically conductive heating element, and an optical waveguide. The dielectric support layer is on the surface of the substrate, and the dielectric support layer comprises a dielectric material. The electrically conductive heating element is on the dielectric support layer. The optical waveguide is on the dielectric support layer, and the optical waveguide comprises a waveguide material different than the dielectric material of the dielectric support layer. The power supply circuitry is on the substrate, and the power supply circuitry is configured to provide electrical current through the heating element to drive thermal emission of optical output from the heating element due to electrical resistive heating, and at least a portion of the optical output is coupled into the waveguide. The photonic component is on the substrate, and the optical waveguide is optically coupled with the photonic component so that the portion of the optical emission is coupled through the optical waveguide to the photonic component on the substrate.

According to still other embodiments of inventive concepts, an optical source includes a substrate, a dielectric support layer, an optical emission element, and an optical waveguide. The substrate has a surface and defines a trench in the surface. The dielectric support layer is on the surface of the substrate, and the dielectric support layer comprises a dielectric material. Moreover, opposite ends of the dielectric support layer are supported on the surface of the substrate on opposite ends of the trench, and a central portion of the dielectric support layer is suspended across the trench with the trench defining a void between the central portion of the dielectric support layer and the substrate. The optical emission element is on the central portion of the dielectric support layer, and the void is between the optical emission element and the substrate. The optical waveguide is on the central portion of the dielectric support layer, the void is between the optical waveguide and the substrate, and the optical waveguide comprises a waveguide material different than the dielectric material of the dielectric support layer.

According to yet other embodiments of inventive concepts, a photonic integrated circuit (PIC) device includes an optical source, power source circuitry, and a photonic component. The optical source includes a substrate, a dielectric support layer, an optical emission element, and an optical waveguide. The substrate has a surface, and the substrate defines a trench in the surface thereof. The dielectric support layer is on the surface of the substrate, and the dielectric support layer comprises a dielectric material. Moreover, opposite ends of the dielectric support layer are supported on the surface of the substrate on opposite ends of the trench, and a central portion of the dielectric support layer is suspended across the trench with the trench defining a void between the central portion of the dielectric support layer and the substrate. The optical emission element is on the central portion of the dielectric support layer, and the void is between the optical emission element and the substrate. The optical waveguide is on the central portion of the dielectric support layer, the void is between the optical waveguide and the substrate, and the optical waveguide comprises a waveguide material different than the dielectric material of the dielectric support layer. The power source circuitry is on the substrate, the power source circuitry is configured to provide electrical current through the optical emission element to drive optical output from the optical emission element, and at least a portion of the optical output is coupled into the waveguide. The photonic component is on the substrate, and the optical waveguide is optically coupled with the photonic component so that the portion of the optical output is coupled through the optical waveguide to the photonic component on the substrate.

### BRIEF DESCRIPTION OF THE DRAWINGS

Examples of embodiments of inventive concepts may be more clearly understood from the following detailed description taken in conjunction with the accompanying drawings in which:

FIG. 1A is a graph illustrating calculated single-mode blackbody spectrums resulting from thermal emission;

FIG. 1B is a schematic diagram illustrating a thermal emitter according to some embodiments of inventive concepts;

FIG. 1C is a schematic diagram illustrating an unbalanced-MZI used to measure waveguide temperatures;

FIG. 1D is a graph illustrating extracted temperature as a function of heater power according to some embodiments of inventive concepts;

FIG. 1E illustrates thermal simulations and temperatures across the waveguide along a trench length according to some embodiments of inventive concepts;

FIG. 2A is a schematic diagram illustrating a setup to align a collection lensed fiber with a waveguide according to some embodiments of inventive concepts;

FIG. 2B is a schematic diagram illustrating a setup to measure a thermal emission spectrum of a broadband optical source according to some embodiments of inventive concepts;

FIG. 2C is a graph illustrating measured spectrums for an optical source at different powers according to some embodiments of inventive concepts;

FIG. 3A is a graph illustrating waveguide-coupled thermal emission power spectral density at different powers for an optical source according to some embodiments of inventive concepts;

FIG. 3B is a graph illustrating waveguide-coupled thermal emission power spectral density for optical sources having different gaps according to some embodiments of inventive concepts;

FIG. 4A illustrates surface-normal IR images of optical sources having different heater lengths according to some embodiments of inventive concepts;

FIG. 4B is a graph illustrating extracted integrated optical powers in optical sources having different gaps and/or heater lengths according to some embodiments of inventive concepts;

FIG. 4C is a graph illustrating source efficiencies in optical sources having different gaps and/or heater lengths according to some embodiments of inventive concepts;

FIG. 5 is a graph illustrating measured polarization-dependent thermal emission for an optical source according to some embodiments of inventive concepts;

FIG. 6A is a graph illustrating simulation of a mode-dependent emissivity of an optical source according to some embodiments of inventive concepts;

FIG. 6B is a graph illustrating simulated mode-dependent emissivity of an optical source at different temperatures according to some embodiments of inventive concepts;

FIG. 6C is a graph illustrating simulated sums of emission from optical sources of FIG. 6B;

FIG. 7 is a top schematic view of an optical source according to some embodiments of inventive concepts;

FIGS. 8A, 8B, 8C, 8D, and 8E are cross-sectional views taken along respective section lines of FIG. 7 according to some embodiments of inventive concepts;

FIG. 9 is a top schematic view of a photonic integrated circuit device including the optical source of FIGS. 7 and 8A-E according to some embodiments of inventive concepts;

FIG. 10A is a top schematic view of an optical source according to some embodiments of inventive concepts;

FIGS. 10B and 10C are cross-sectional views taken along respective sections lines of FIG. 10A according to some embodiments of inventive concepts;

FIG. 11A is a top schematic view of an optical source according to some embodiments of inventive concepts;

FIGS. 11B and 11C are cross-sectional views taken along respective section lines of FIG. 11A according to some embodiments of inventive concepts.

### DETAILED DESCRIPTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes (including thicknesses, lengths, widths, etc.) of each of the elements may be exaggerated for clarity and conveniences of explanation.

Light sources monolithically integrated with optical filters, modulators, and detectors are useful for photonic systems on a chip. For applications such as chemical or biological sensing using absorption spectroscopy, broadband light sources may be preferred over lasers or amplified spontaneous emission sources. In particular, thermal sources may offer broadband optical emission. However, to date there have been few reports of foundry processed, waveguide-coupled thermal sources. In the present disclosure, a suspended nanophotonic waveguide-coupled blackbody source (i.e. a one dimensional broadband emitter or lightbulb) is demonstrated. It is heated by an adjacent resistive heater that permits temperatures in excess of 1000° C. for electrical powers of tens of mW. The waveguide coupled emission was measured confirming broadband operation from 875-1680 nm (instrumentation limited). Thermal simulations show good agreement with measurements, and optical modeling accurately describes the heater-waveguide coupling and polarization.

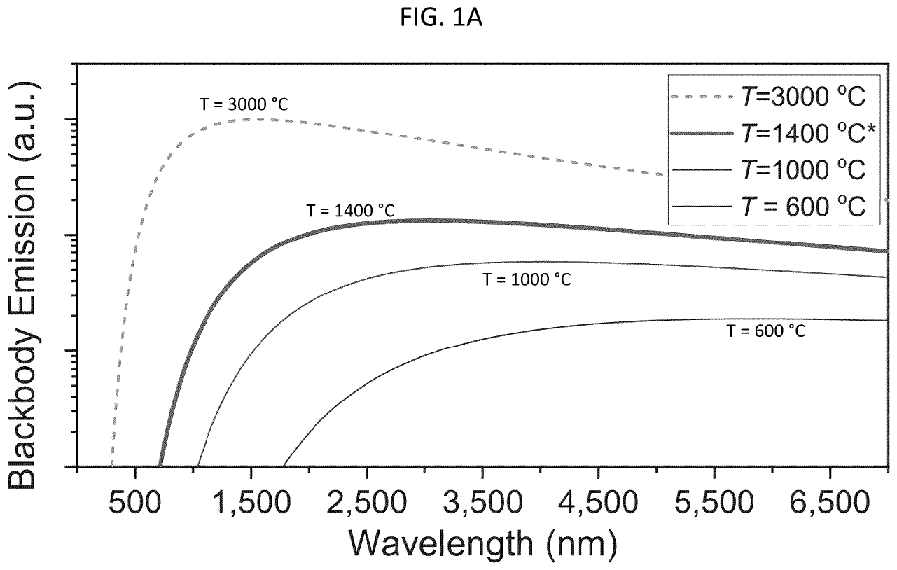

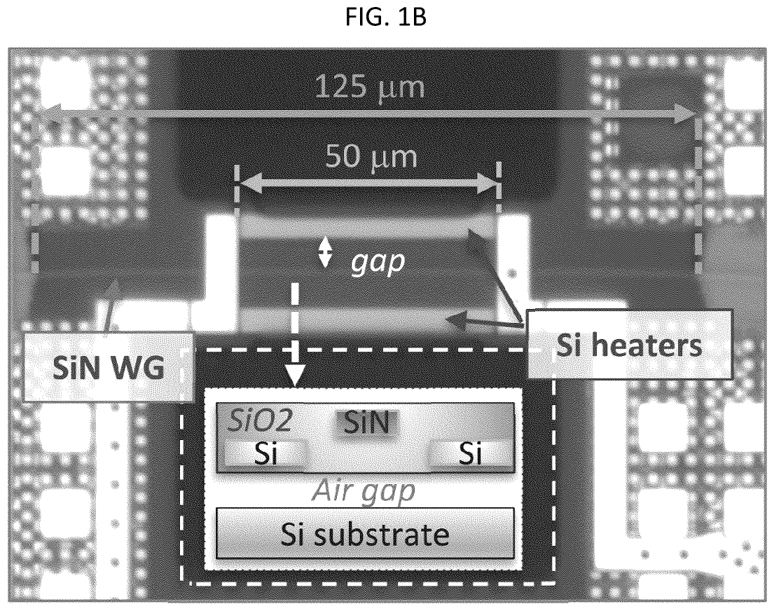

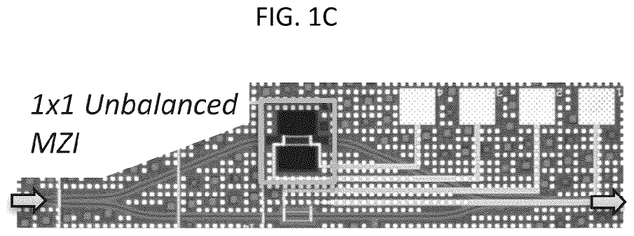

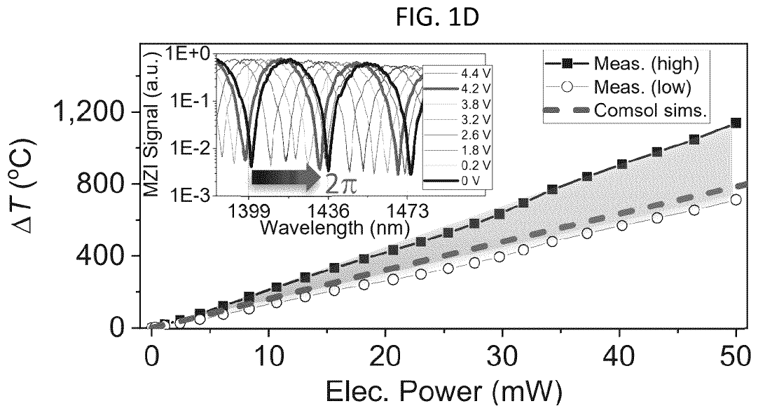

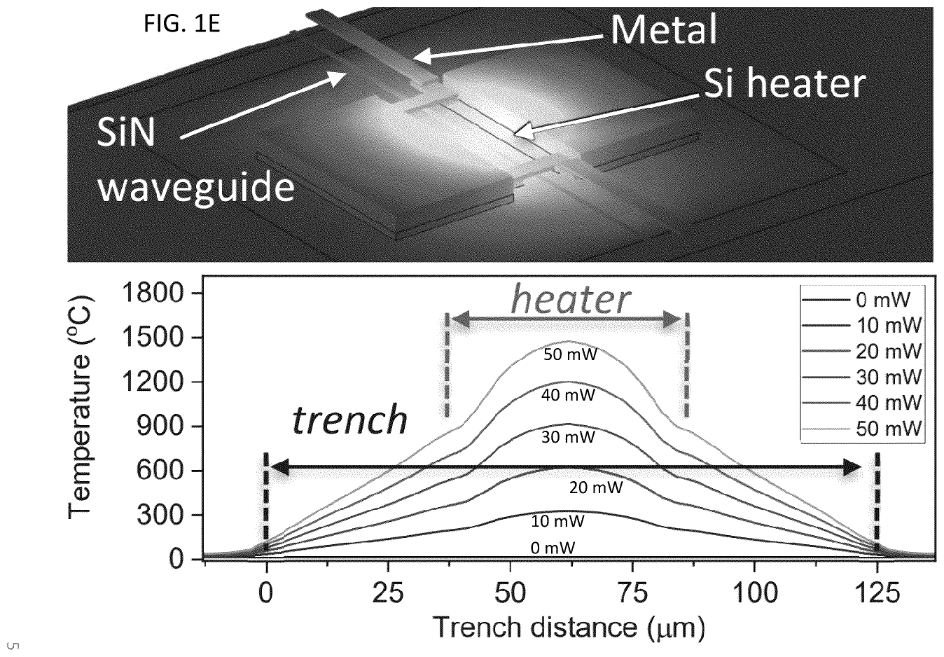

In the present disclosure, a waveguide-coupled broadband optical source is demonstrated based on an electrically-heated silicon nitride (SiN) waveguide with an adjacent doped-Si microheater. Broadband waveguide-coupled emission was demonstrated from 875-1680 nm (instrumentation limited). Thermal and optical modeling based on one-dimensional blackbody emission (see Reference [23]) show good agreement with measurement and elucidate the contributions from the SiN and Si regions on the observed emission spectrum and polarization. Thermal emission can be described using Planck's law of radiation. For emission into single-mode optical waveguides one must account for the modified (one-dimensional) density of states (see References and [23]), to describe waveguide-coupled thermal emission. FIG. 1A illustrates calculated single-mode (1-D) blackbody spectrum. FIG. 1B illustrates a fabricated thermal emitter with a 50 μm Si-heater length and a 125 μm trench undercut length. FIG. 1C illustrates an unbalanced-MZI used to measure the waveguide temperature. FIG. 1D illustrates extracted temperature vs. heater power for a measured 0-2π phase shift. FIG. 1E illustrates COMSOL thermal simulations (top) and temperature across the waveguide along the trench length (bottom). The Comsol simulated temperature in FIG. 1D is the average temperature of the waveguide in the trench region.

As shown in FIG. 1A, thermal emission at wavelengths in the 1 μm to 10 μm range are possible at temperatures of around 1000° C. At T=1400° C. (silicon's melting temperature), the peak emission is at λ≈3000 nm. Thermal emitters according to some embodiments of the present disclosure may be fabricated in a commercial 300 mm CMOS foundry (AIM Photonics) and may include two 220 nm thick doped-Si heaters placed next to (2.5 μm to 6.5 μm away from) and 100 nm below a 220 nm thick SiN optical waveguide (see Reference [1]). The Si/SiN structures are clad in silicon dioxide (SiO₂). On either side of the Si/SiN structure, the cladding is etched to reveal the silicon bottom substrate. Then, the substrate itself is etched away such that the oxide clad Si/SiN structure is suspended in air. The substrate undercut results in a suspended structure that is longer than the heater; e.g. a 50 μm long heater is suspended and thermally isolated over a 125 μm long waveguide segment as shown in FIG. 1B.

Heater temperature was measured using an unbalanced Mach-Zehnder interferometer (MZI) in which the longer arm (ΔI_{MZI}=30 μm) is suspended via a trench undercut as shown in FIG. 1C. The suspended waveguide arm is heated by applying a current to the Si heaters. Light from a tunable laser is sent through the device in the TE00 mode and the MZI spectrum is measured, as shown in FIG. 1D. From the measured MZI fringe shift, the waveguide temperature vs. heater power can be measured (see Reference [24]). Using the 125 μm long trench as the phase shift region results in a maximum temperature of 1100° C. (averaged across the 125 μm waveguide segment) at ˜50 mW heater power as shown in FIG. 1D (filled squares) assuming room temperature thermo-optic](TO) coefficients of TO_{SiN}=2.45×10⁻⁵/K and TO_{SiO2}=0.95×10⁻⁵/K, respectively (see Reference [25]). However, the SiN and SiO₂ TO coefficients are temperature-dependent (see References and [27]). The TO coefficient of SiO₂ has been measured at temperatures as high as 1200° C. 27, and SiN's TO coefficient can be interpolated from temperature-dependent data (see Reference [26]), which results in TO coefficients up to 50% higher at 1000° C. vs. room temperature. The thermo-optic increase in the refractive indices at high temperatures (of the order of a few percent) also results in a small change in the mode overlap with the SiN and SiO₂ regions. Taking the modified refractive indices, TO coefficients,

and modal overlap into account results in a maximum average temperature of ≈800° C. at 50 mW electrical power (as shown by the open circles of FIG. 1D) along the trenched region of the waveguide. The large uncertainty in the temperature extraction is attributed primarily to the uncertainty in SiN's TOC at elevated temperatures.

To more accurately characterize the temperature distribution in the emitter, the released structure was modeled in Comsol using the Heat Transfer package. A 3D model of the suspended structure was constructed, including metal contacts and interconnects of FIG. 1E. The simulations show that the metal traces represent a significant path for heat loss and that these should be included in the model to obtain an accurate temperature distribution of the heater-waveguide structure. The doped-Si heaters were modeled as general volumetric heat sources and electrical losses through the metal contacts were neglected. The top of the oxide cladding above the emitter was assigned a heat flux boundary condition of 10 W/(m²K) to replicate convective heat lost to the ambient environment. The flux at the bottom of the silicon substrate and ends of the metal traces was set to 10×10¹¹ W/(m²K) (see Reference [28]) to replicate conductive heat lost to perfect heat sinks. All other boundaries were set to the default thermal insulation condition. To extract the waveguide temperature distribution, a 3D line-cut was placed in the center of the SiN waveguide.

The temperature along the waveguide for each of these powers is plotted in FIG. 1E. The 125 μm long suspended region that includes the Si heaters was taken as the effective phase shifting region and the average temperature of the waveguide in that region as a function of heater power is shown in FIG. 1D (dashed line). This agrees well with the waveguide temperature extracted from measured phase shifts when considering temperature-dependent refractive indices, TOC's and modal overlaps. To highlight the importance of the trench undercut in enabling thermal emission, simulations with and without the trench were compared. Without the isolation trench, a maximum waveguide temperature of 101° C. at 50 mW heater power is simulated. In contrast, a maximum waveguide temperature of 1450° C. at 50 mW heater power is seen with the isolation trench in place.

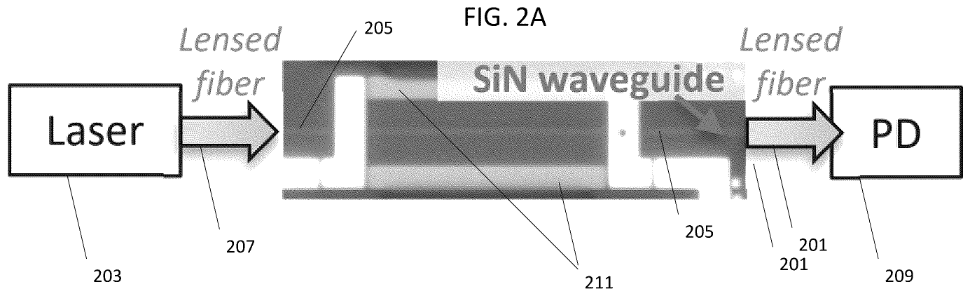

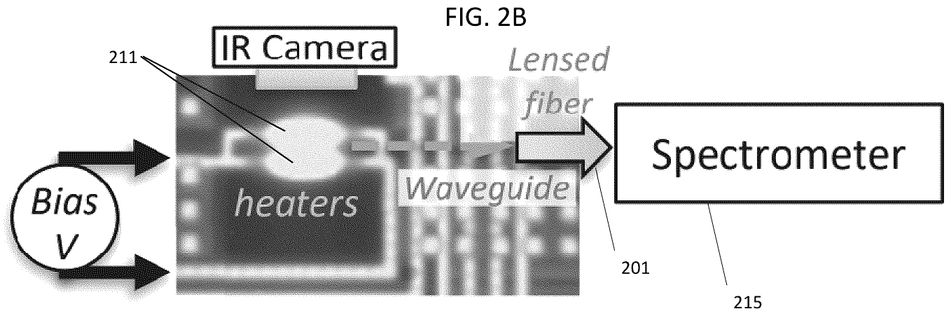

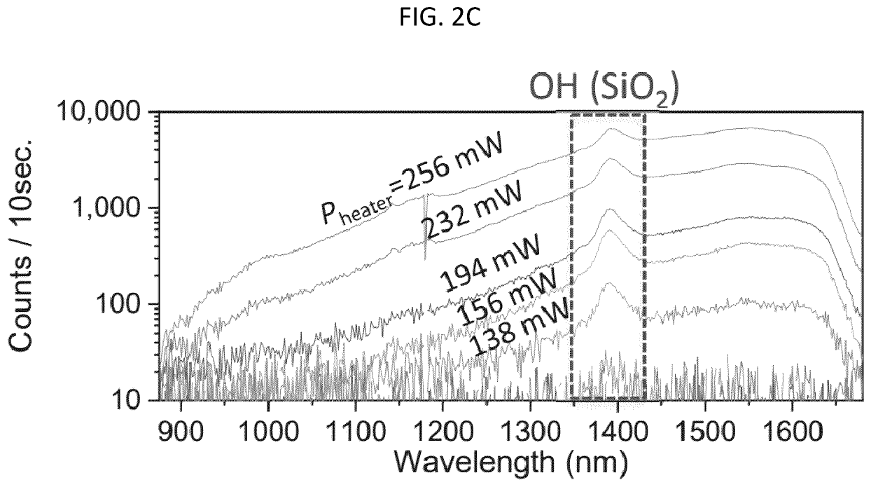

FIGS. 2A-C illustrate thermal emission spectrum measurements are discussed below with respect to FIGS. 2A, 2B, and 2C, where FIG. 2A illustrates a setup used to align the collection lensed fiber, FIG. 2B illustrates a setup used to measure the thermal emission spectrum, and FIG. 2C illustrates measured spectrum for a device with lₕₑₐₜₑᵣ=1500 μm and gap=6.5 μm. In FIG. 2A, PD is an anacronym for photodetector. The experimental setup of FIGS. 2A and 2B is discussed below. To collect emission from the waveguide, the waveguide output facet is aligned to a polarization-maintaining single-mode lensed fiber 201 (Oz Optics TPMJ). To do this, laser light (λ=1430 nm) from laser 203 is coupled into the input of the waveguide 205 using a second lensed fiber 207. After maximizing laser transmission into photodetector 209 as shown in FIG. 2A, laser 203 is turned off, a bias is applied to heaters 211, and output lensed fiber 201 is connected to the input of spectrometer 215 (Wasatch WP NIR). Thermal emission was first qualitatively observed via IR surface-normal near-infrared imaging (Sensors Unlimited) as shown in FIG. 2B. The measured emission spectrum in FIG. 2C is provided for a device with a heater length lₕₑₐₜₑᵣ=1500 μm and a lateral heater-waveguide separation gap=6.5 μm confirms broadband emission over λ=875 nm to 1680 nm, limited by the spectrometer and measurement setup. The emission shows a strong increase at longer wavelengths consistent with a blackbody thermal source. An emission peak was also observed at λ≈1390 nm which is attributed to an OH-absorption feature resulting from hydrogen in the SiO₂ cladding (see References and [30]). Note that the measurements in FIG. 2C show raw spectra and do not account for the spectrometer responsivity, waveguide-fiber coupling loss, and waveguide polarization-dependence, all of which are discussed below.

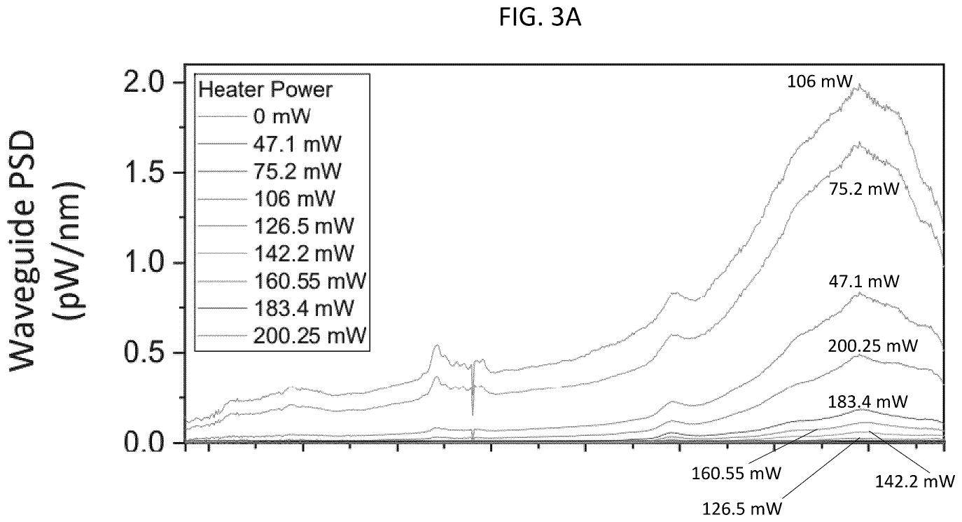

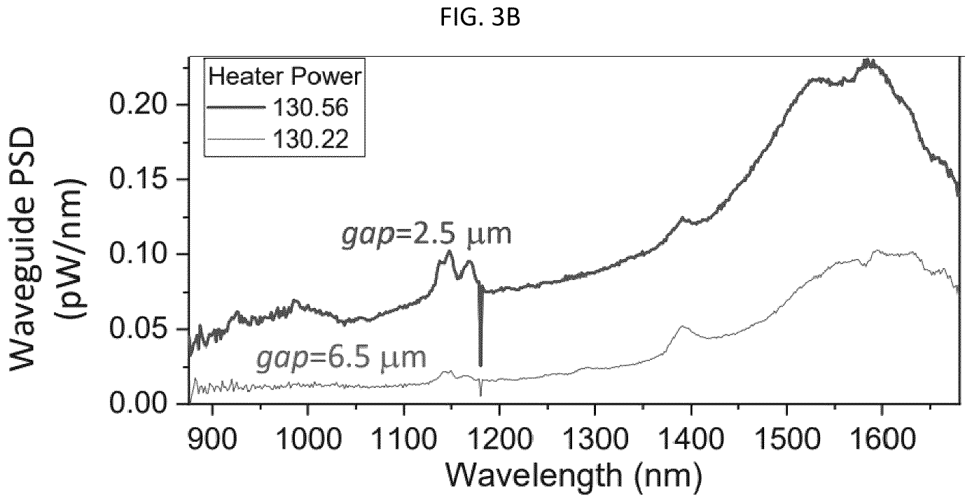

In order to extract the one-dimensional thermal emission power internal to the waveguide, the spectrometer's responsivity was first calibrated using lasers with known optical power. Separately, the waveguide-fiber coupling loss spectrum was measured using a white light source (Thorlabs SLS-201). Although the thermal emission propagates down the waveguide in both directions, light was only collected from one end facet. Accounting for this, the waveguide optical power spectral density (PSD) was extracted as shown in FIGS. 3A and 3B. The longest device measured (lₕₑₐₜₑᵣ=1500 μm) with a waveguide-heater gap=2.5 μm in FIG. 3A shows broadband emission across the spectrometer's operating range from λ=875 nm to 1680 nm. At short wavelengths the decreased PSD is attributed to the wavelength dependence of one-dimensional thermal emission (see Reference [23]) and inefficient coupling between the SiN waveguide and the Si heater inside the emitter (See Section IV A). At long wavelengths (λ>1600 nm) the drop in measured waveguide power (PSD) results from the polarization- and wavelength dependent substrate coupling that leads to a pronounced TM loss at long wavelengths. Although the TE00-mode does not exhibit pronounced substrate loss at long wavelengths, the waveguide thermal emission appears to be dominated by the TM00-mode at λ>1600 nm as will be shown.

FIG. 3B shows the measured PSD for lₕₑₐₜₑᵣ=500 μm devices with waveguide-heater gap=2.5 μm and 6.5 μm. The smallest gap results in the strongest PSD with decreasing waveguide-coupled thermal emission as the heater-waveguide separation increases. This dependence results from the increased modal overlap with the high-emissivity Si heaters as the SiN and Si regions are brought into closer proximity.

Emitted power from the experimental setup of FIGS. 2A and 2B is discussed below with respect to FIGS. 3A, 3B, and 3C. FIG. 3A illustrates waveguide-coupled thermal emission power spectral density (PSD) for a device with lₕₑₐₜₑᵣ=1500 μm and gap=2.5 μm at heater powers of P_{elec}-0 to 200 mW. FIG. 3B illustrates waveguide-coupled thermal emission power spectral density (PSD) for a device with lₕₑₐₜₑᵣ=500 μm, gap=2.5 μm and 6.5 μm at P_{elec}=130 mW.

The internal optical power is found by integrating the PSD in FIGS. 3A and 3B from 2=875 to 1680 nm. This bandwidth-limited power may underestimate the total emitted internal power in the waveguide since the blackbody emission shown in FIG. 1A extends to wavelengths outside the spectrometer's measurement bandwidth.

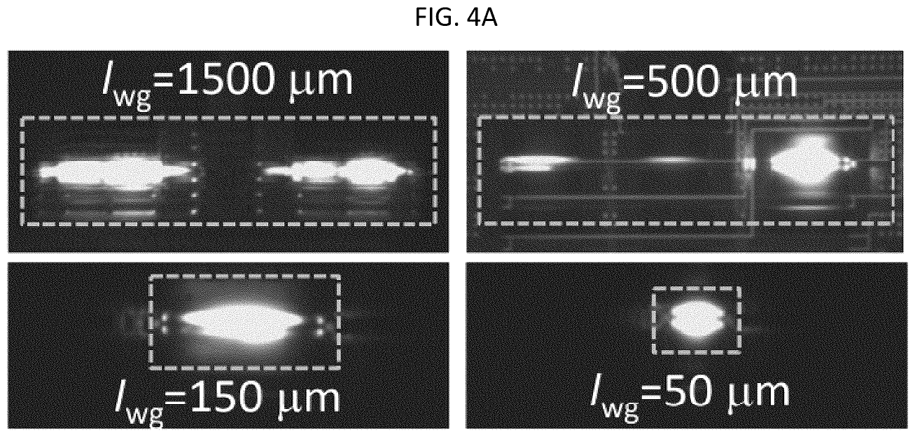

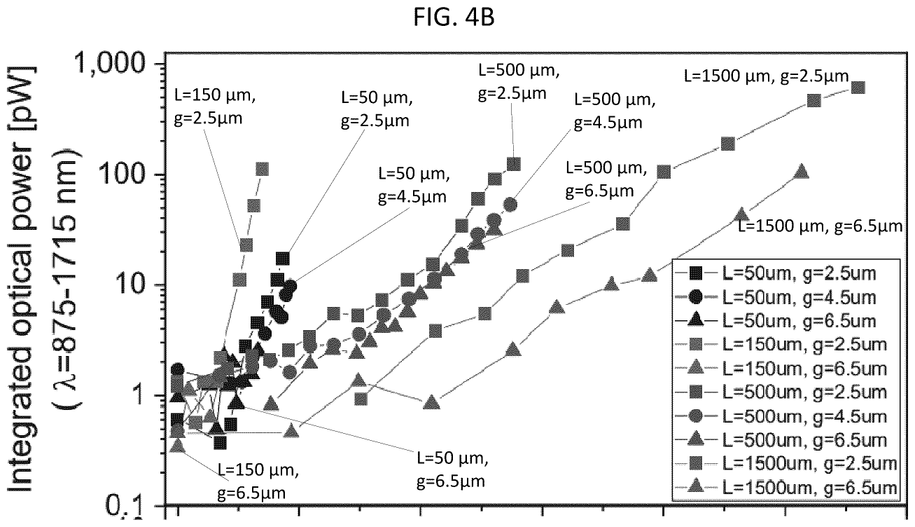

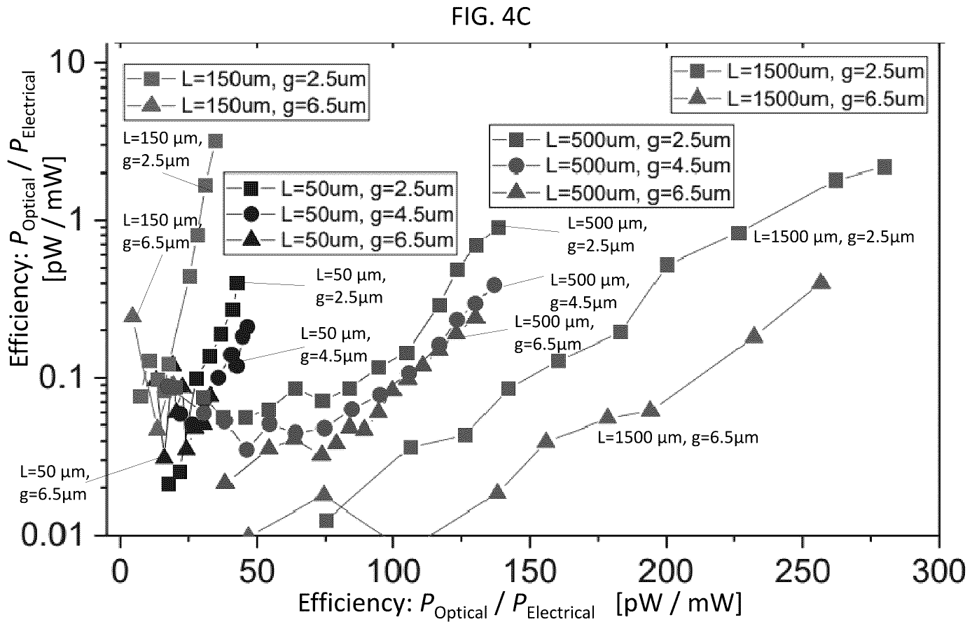

Broadband thermal source efficiency is discussed with respect to FIGS. 4A, 4B, and 4C. In FIG. 4A, surface-normal IR images show non-uniform emission from longer devices with lₕₑₐₜₑᵣ=500 μm and 1500 μm contributing to lower measured efficiency. FIG. 4B illustrates extracted integrated optical power in waveguides over λ=875 nm to 1715 nm. FIG. 4C illustrates source efficiency. Note that images in FIG. 4A have different magnifications.

The bandwidth limited waveguide optical powers of thermal emitters of FIG. 4A with device lengths of lₕₑₐₜₑᵣ=1500 μm, 500 μm, 150 μm, and 50 μm were measured.

(FIG. 4B shows that the largest waveguide-coupled power is obtained in the longest device (lₕₑₐₜₑᵣ=1500 μm with the smallest waveguide-heater separation (gap=2.5 μm): around 1 nW. In general, shorter devices may require less electrical power due to their smaller thermal mass, although the maximum thermal emission may be limited by the maximum heater power that can be applied before burnout.

Defining the efficiency as P_{optical}/P_{electrical}, the lₕₑₐₜₑᵣ=150 μm (gap=2.5 μm) device is the most efficient and longer devices exhibit lower efficiency as shown in FIG. 4C. Although the shortest device (lₕₑₐₜₑᵣ=50 μm) can be expected to require the lowest electrical power, its lower efficiency can be attributed to the reduced optical coupling length compared to e.g. the lₕₑₐₜₑᵣ=150 μm device. The longer devices (lₕₑₐₜₑᵣ=500 μm and 1500 μm) can support higher P_{electrical} but also have a larger thermal mass thereby reducing their efficiency. Surface normal infrared (IR) imaging also suggests that these longer devices are not heating uniformly as shown in FIG. 4A. Thermal modeling indicates that this results from heat flow along the metal traces as well as support structures required to suspend the waveguide and heater. In contrast, the shorter devices (lₕₑₐₜₑᵣ=50 μm and 150 μm) show thermal emission over the entire suspended heater-waveguide length as these do not require multiple support structures and are not crossed by metal traces. The presence of these supports and metal traces for the longer devices (500 μm and 1500 μm) make it difficult to compare them to the shorter (50 μm and 150 μm) emitters in terms of efficiency while foundry design rules may necessitate these design modifications for the longer suspended structures.

Polarization of the thermal emission from the waveguide emitter was investigated using a modified setup similar to that of FIG. 2A. Calibration has shown negligible polarization dependence in the spectrometer. This enables the separation of the TE- and TM-polarized components of the waveguide-coupled thermal emission by using a polarizer at the input of the spectrometer and by using the polarization-dependent waveguide-fiber coupling loss in the PSD calibration.

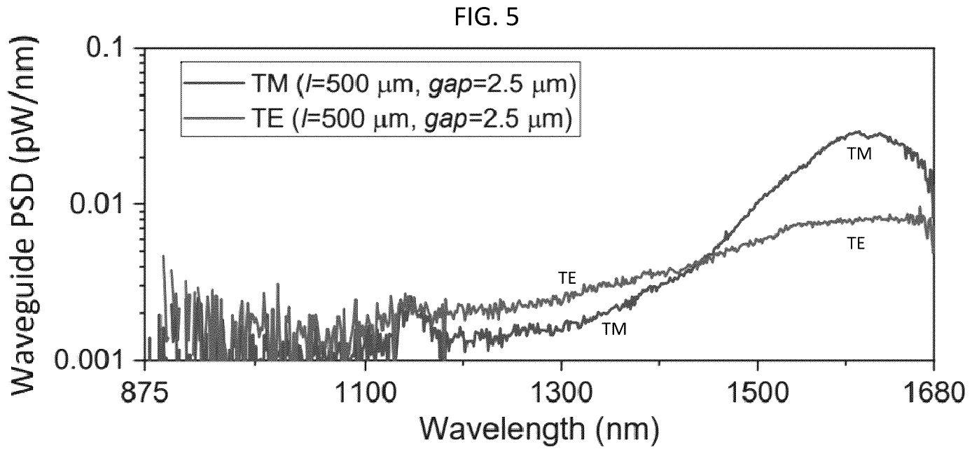

FIG. 5 is a graph illustrating measured polarization-dependent thermal emission for a device with lₕₑₐₜₑᵣ=500 μm and gap-2.5 μm. Measurements in FIG. 5 show that TM-polarization dominates at wavelengths longer than λ≈1300 nm due to increased overlap of the SiN TM optical mode with the emissive Si heater region. However, at wavelengths beyond λ≈1500 nm the TM00-mode exhibits increasing substrate loss due to the large interaction of the evanescent field with the Si substrate.

Optical Modeling and Comparison to Experiment are discussed below. The PSD of a 1-dimensional (1D) emitter into a single mode is given by:

$${ρ}_{1 D} ( λ , T ) = {e}_{1 D} ( λ , T ) {ρ}_{1 DBB} ( λ , T ) \qquad Equation ( 1 )$$

where ρ_{1D}(λ, T) is the emitted PSD, β_{1DBB}(λ, T) is the blackbody emission spectrum into a single mode (see Reference [23]), and e_{1D}(λ, T) is the emissivity of the emitter into the mode of interest. From Kirchoff's law, the emissivity of the device into a given mode is equal to the absorptivity α_{1D}(λ, T) of that mode by the emitter. For a SiN heater-waveguide structure of length lₕₑₐₜₑᵣ:

$${a}_{1 D} ( λ , T ) = 1 - {e}^{- α ( λ , T ) {l}_{h e a t e r}} \qquad Equation ( 2 )$$

where α(λ, T) is the mode power absorption coefficient in the heater region.

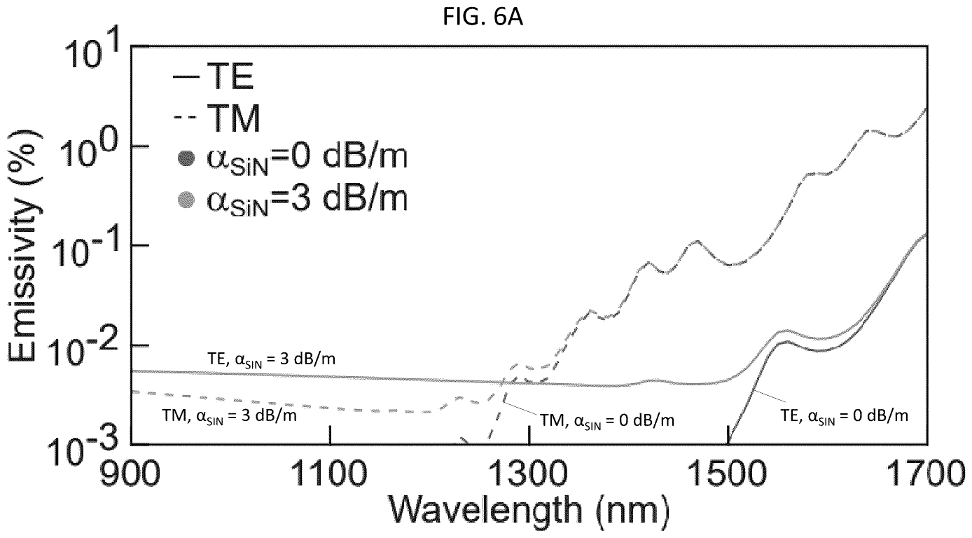

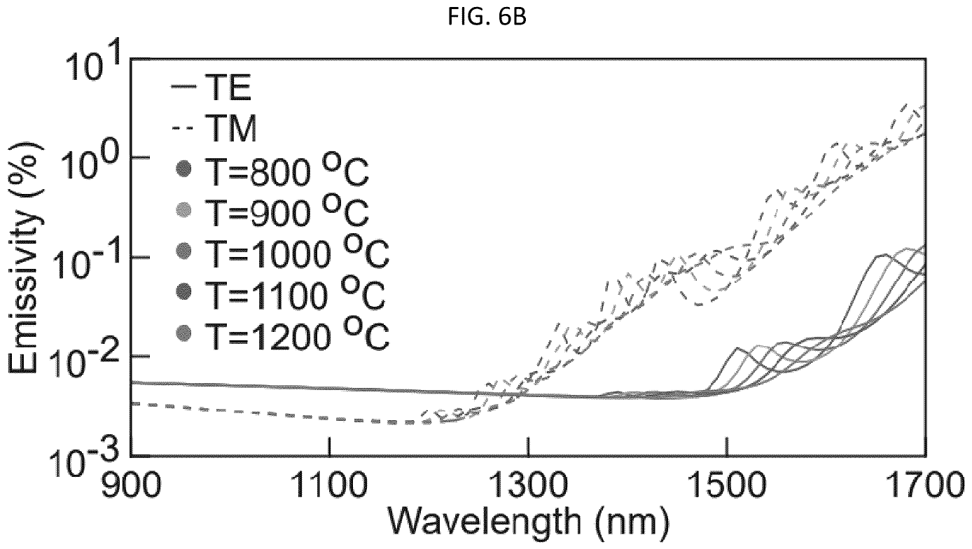

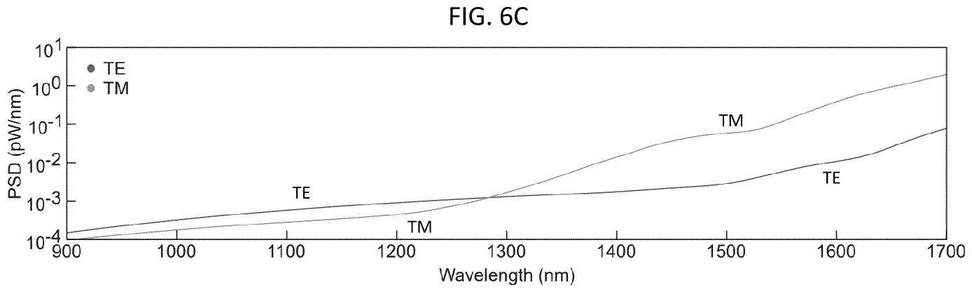

To calculate the absorptivity and hence the emissivity of devices disclosed herein, the heater-waveguide structure with a 2.5 μm heater gap is modeled using COMSOL, and the propagation loss coefficient α(λ, T) of both the fundamental TE and TM modes of the SiN waveguide is extracted as shown FIGS. 6A, 6B, and 6C. FIG. 6A illustrates results of simulation of the mode-dependent emissivity of a 100 μm long heater-waveguide device at a temperature of 1000° C. with SiN emission (α_{SiN}=3 dB/m) and without (α_{SiN}=0 dB/m). FIG. 6B illustrates results of simulated mode-dependent emissivity of a 100 μm long heater-waveguide device including SiN emission for T=800° C. to 1200° C. FIG. 6C illustrates results of a simulated sum of emission from the five devices shown in FIG. 6B.

While higher-order modes exist in the SiN waveguide at shorter wavelengths, these modes do not couple efficiently to the lensed fibers used to collect emission from the device and are therefore neglected in the simulation. Material absorption must be considered for both the Si heaters and the SiN core for an accurate estimation of the emissivity. The Si absorption coefficient α_{Si}(λ, T) was taken from Reference using the carrier concentrations in Si calculated from Reference [32], with an additional temperature-independent electron concentration n_{D} added to account for doping in the Si heater. The weak absorption in the SiN core (α_{SiN}=3 dB/m) is also included in the model, and is assumed to be constant with wavelength (taken from Reference [33]; no absorption data of SiN at temperatures near 1000° C. could be found). The total absorption coefficient α(λ, T) for a given mode is a function of both α_{Si} and α_{SiN}, as well as the overlap of the mode with each region. Once α(λ, T) is calculated, the total emissivity (absorptivity) of the heater structure for a given mode is calculated from equation (2).

FIG. 6A shows the calculated emissivity of a heater at 1000° C. with lₕₑₐₜₑᵣ=100 μm in the case where SiN absorption is neglected (α_{SiN}=0 dB/m) compared to the case of weak SiN absorption α_{SiN}=3 dB/m. This figure shows that at wavelengths below 1200 nm the emission is entirely from the SiN core, since mode confinement reduces/prevents overlap with the Si heaters. FIG. 6A also shows that the emissivity of the TM₀₀ mode is significantly stronger than the TE₀₀-mode at longer wavelengths due to the lower confinement of the TM mode and therefore stronger overlap with the Si heaters. The peaks in the emissivity at longer wavelengths occur when the mode is degenerate with a higher order mode of the isolated Si heaters.

The temperature of thermal emitters of the present disclosure may be highly nonuniform, as shown in FIG. 4A and confirmed by COMSOL thermal simulations in FIG. 1E. To account for this nonuniform temperature distribution, the simulation was repeated for temperatures ranging from 800° C. to 1200° C., as shown in FIG. 6B. As the temperature changes, the peaks in the calculated emissivity shift significantly due to the thermo-optic coefficients of Si, SiN, and SiO₂. While measured thermo-optic data in SiO₂ up to temperatures of 1200° C. are reported (see Reference [34]), data at high temperatures were unavailable for Si and SiN. As a result, the thermo-optic coefficients for these materials were extrapolated from the lower temperature data (see References and [36]). FIG. 6C shows the total emission from a five-heater series (i.e., five 100 μm long segments at five temperatures for a 500 μm total device length), displaying good qualitative agreement with the measured data in FIG. 5B for a 500 μm long device. The TM mode shows approximately an order of magnitude stronger emission than the TE mode at wavelengths greater than 1500 nm due to increased modal overlap with the Si heaters. Measured polarization-dependent emission of FIG. 5B exhibits a drop in TM emission beyond 1600 nm due to increased substrate leakage at longer wavelengths; this is not included in the model of the present disclosure. Although the model of the present disclosure shows good qualitative agreement with measurement, exact quantitative agreement between simulation and measurement would require knowledge of the precise temperature profile of the device alongside the exact emittivity of all three materials (Si, SiN, SiO₂) at these elevated temperatures and dopant concentrations, all of which are difficult to quantify at high temperatures.

A potential limitation on the efficiency of emitter structures of the present disclosure is their low emissivity, which is shown to be less than 10% at all wavelengths for a 100 μm long device (see FIG. 6B). In order to increase the emissivity of the device, its length can be increased. However, this may come at the cost of increased power consumption required to reach a given temperature. Instead, it may be better to increase the emissivity by designing a heater structure in which the optical mode overlaps strongly with the doped Si while maintaining nearly unity coupling out of the heated region. For example, by moving from the nearly lossless SiN waveguide core to a lossy doped Si core within the heater region, nearly 100% emissivity over a 100 μm length can be achieved, allowing for increased/maximized emission without an increase in device length.

By integrating the 1D blackbody spectrum (see Reference [23]) over wavelength from 900 nm to 1700 nm, the total bandlimited power of an ideal emitter into a single mode and direction may be obtained as a function of temperature. For a temperature of 1000° C., this yields an idealized band-limited power of 4.6 nW. If a temperature of 1000° C. is estimated at a heater power of 50 mW (section II B), and both propagation directions are accounted for, a maximum band-limited efficiency of 184 pW/mW can be expected for a device with unity emissivity. This corresponds to a 60-fold improvement over the devices shown in FIG. 4B, provided that the emitted power measured for the devices is assumed to primarily result from a single mode (FIG. 5).

In conclusion, a foundry-processed, one-dimensional waveguide thermal emitter has been demonstrated. The optical source is entirely compatible with the foundry's existing process and uses only doped silicon and silicon nitride. The broadband emission is measured over almost a whole octave, λ=875 nm to 1680 nm, limited by instrumentation. The maximum bandwidth-limited integrated optical power in the disclosed waveguide emitter (measured over λ=875′nm to 1680 nm) was nearly 1 nW, with efficiencies >1 pW/mW. Although this power is modest, previous work has shown that this is more than sufficient for practical applications including on-chip photonic component characterization and chemical sensing using waveguide infrared absorption spectroscopy (WIRAS), see Reference [22]. Optical modeling of 1D-thermal emission in single-mode waveguides has shown that significant efficiency gains can be achieved by increasing/maximizing the overlap of the optical mode with an absorptive and hence emissive waveguide material. The nanophotonic broadband thermal emitter demonstrated in this work may therefore be an important component for spectroscopic chip-based biological and chemical sensing, and/or for in-situ component characterization and verification.

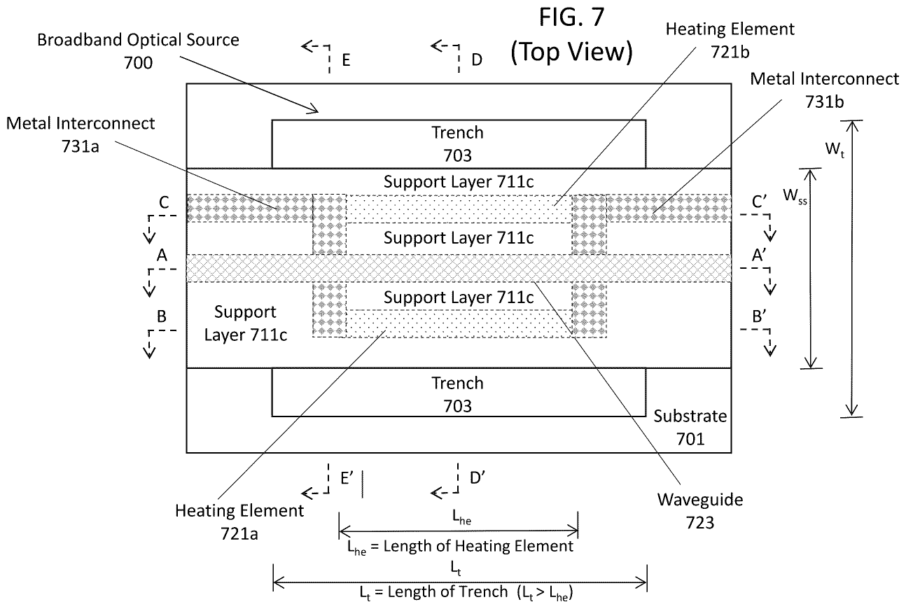

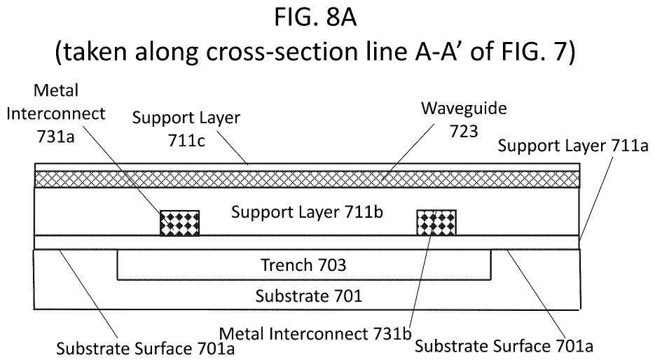

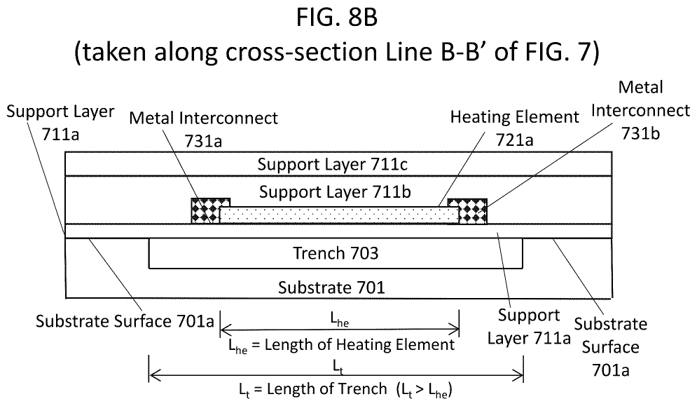

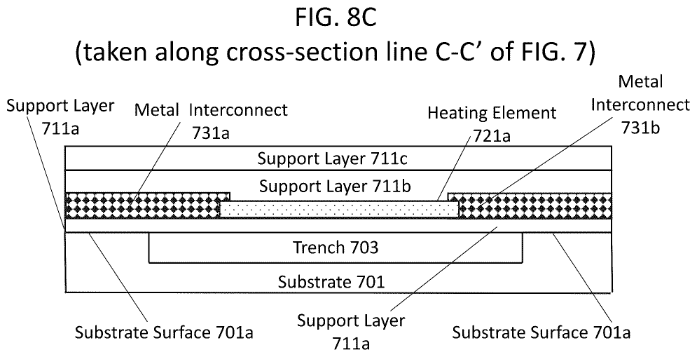

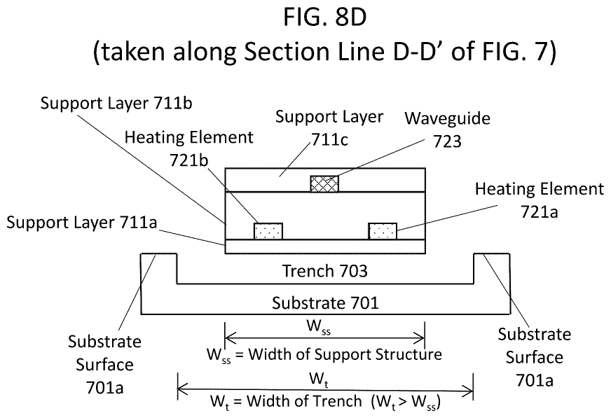

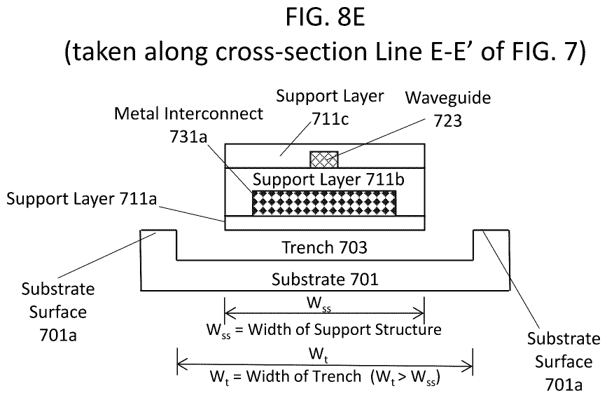

FIG. 7 is a top view of a broadband optical source 700 that may be used in a photonic integrated circuit (IC) according to some embodiments of inventive concepts, and FIGS. 8A, 8B, 8C, 8D, and 8E are cross-sectional views respectively taken along Section Lines A-A′, B-B′, C-C′, D-D′, and E-E′. As shown, a support structure 711 (including dielectric support layers 711a, 711b, and 711c) is suspended across trench 703 in substrate 701, heating elements 721a and 721b are provided between dielectric support layers 711a and 711b, and waveguide 723 is provided between dielectric support layers 711b and 711c. Accordingly, waveguide 723 and heating elements 721a and 721b are clad within the support structure.

In FIG. 7, waveguide 723 (e.g., a silicon nitride SiN waveguide) is shown for purposes of illustration even though waveguide 723 is covered by support layer 711c in the view of FIG. 7. Similarly, heating elements 721a and 721b and metal interconnects 731a and 731b are shown for purposes of illustration in FIG. 7 even through these elements are covered by support layers 711b and 711c in the view of FIG. 7.

While heating elements 721a and 721b and metal interconnects are shown between support layers 711a and 711b and waveguide 723 is shown between support layers 711b and 711c, other arrangements may be provided according to embodiments of inventive concepts. For example, heating elements 721a and 721b and metal interconnects may be provided between support layers 711b and 711c and waveguide 723 may be provided between support layers 711a and 711b. Moreover, while interconnections are illustrated using metal interconnects 731a and 731b, other conductive material(s) may be used to provide electrical connection.

Moreover, metal interconnects 731a and 731b may be used to provide electrical coupling between an electrical power source circuitry 1001 and heating elements 721a and 721b. As shown in FIGS. 7 and 8E, metal interconnect 731a is electrically coupled to first ends of both heating elements 721a and 721b. Metal interconnect 731b is electrically coupled to second ends of both heating elements 721a and 721b. Stated in other words, metal interconnects 731a and 731b may pass under waveguide 723 in the view of FIG. 7 so that each metal interconnect is connected to both heating elements.

As shown in FIG. 7, each heating element 721a and 721b may have a length Lₕₑ that is less than a length Lₜ of trench 703, and a width Wₛₛ of support structure 711 may be less than a width Wₜ of trench 703. An entirety of each of heating elements 721a and 721b is thus suspended over trench 703 thereby reducing thermal coupling between heating elements 721a and 721b and substrate 701. Accordingly, an efficiency of heat generation from heating elements 721a and 721b can be increased thereby increasing an efficiency of thermal emission used to provide broadband optical emission that is coupled into waveguide 703.

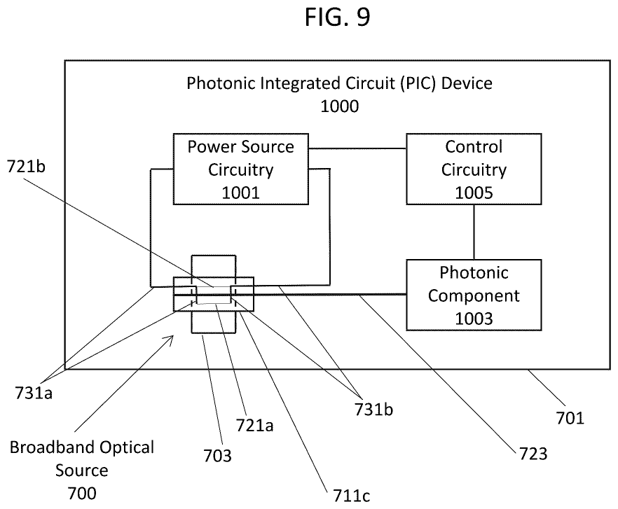

Substrate 703 may include a semiconductor substrate (e.g., a silicon substrate) for a photonic integrated circuit as discussed below with respect to FIG. 9. Substrate 703 may include one or more insulating layers on the semiconductor substrate. Accordingly, trench 703 may be formed entirely in an exposed portion of a semiconductor substrate, trench 703 may be formed through an insulating layer and into a portion of a semiconductor substrate below the insulating layer, or the trench may be formed entirely in an insulating layer on a semiconductor layer (without extending into the semiconductor layer).

FIG. 9 is a schematic top view of a photonic integrated circuit (PIC) 1000 including the broadband optical source 700 discussed above with respect to FIGS. 8 and 7A-E. As shown, metal interconnects 731a and 731b provide electrical coupling between power source circuitry 1001 and each of heating elements 721a and 721b, and waveguide 723 is optically coupled with photonic component 1003. In addition, control circuitry 1005 may be provided to control power source circuitry 1001, to receive/process information from photonic component 1003, and/or to provide an electrical/optical interface to/from electronics/optics outside of PIC 1000.

FIGS. 7, 8A-E, and 9 thus provide further illustration of embodiments of optical sources and PIC devices discussed previously, for example, with respect to FIG. 1B.

Each of broadband optical source 700, power source circuitry 1001, photonic component 1003, and/or control circuitry 1005 may thus be fabricated using electrical and/or optical elements on common substrate 701 (e.g., on a common semiconductor substrate). Power source circuitry 1001 may thus provide electrical current through heating elements 721a and 721b (via metal interconnects 731a and 731b) to provide resistive heating of heating elements 721a and 721b. By providing resistive heating of heating elements 721a and 721b, thermal emission is used to generate the broadband optical output that is coupled into waveguide 723 and transmitted to photonic component 1003.

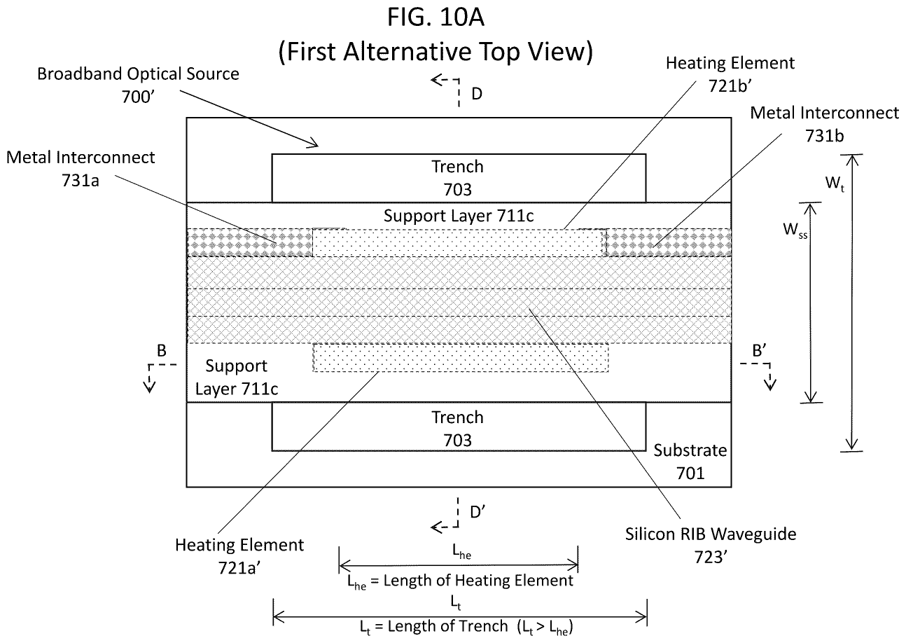

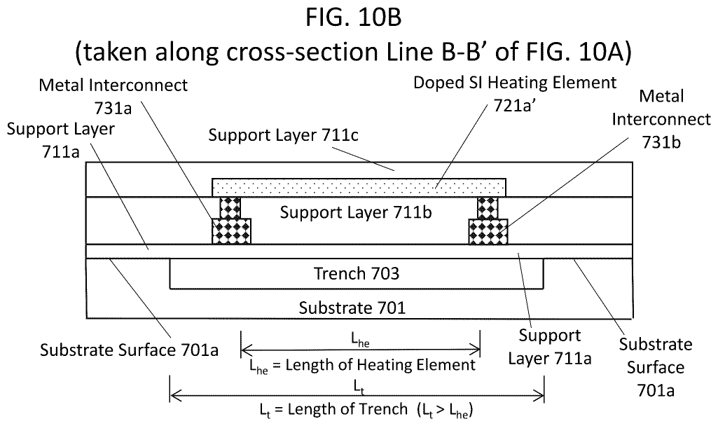

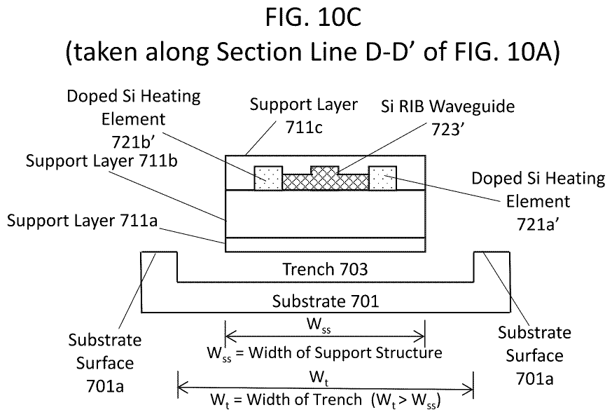

FIGS. 10A, 10B, and 10C illustrate a first alternative to embodiments discussed above with respect to FIGS. 7 and 8A-E. As shown in the top view of FIG. 10A, broadband optical source 700′ may be provided using silicon rib waveguide 723′, and doped silicon heating elements 721a′ and 721b′ may be provided at a same level as silicon rib waveguide 723′. As shown in FIGS. 10B and 10C, Si rib waveguide 723′ and doped Si heating elements 721a′ and 721b′ are between support layers 711b and 711c, and metal interconnects 731a and 731b are between support layers 711a and 711b. Accordingly, conductive vias through support layer 711b may provide electrical coupling between heating elements 721a′/721b′ and respective metal interconnects 731a/731b. In such embodiments, heating elements 721a′ and 721b′ and rib silicon waveguide 723′ may be patterned from a single layer of silicon. Structures including silicon rib waveguides are discussed by Lipkowitz et al. in Reference [44], the disclosure of which is hereby incorporated herein in its entirety by reference.

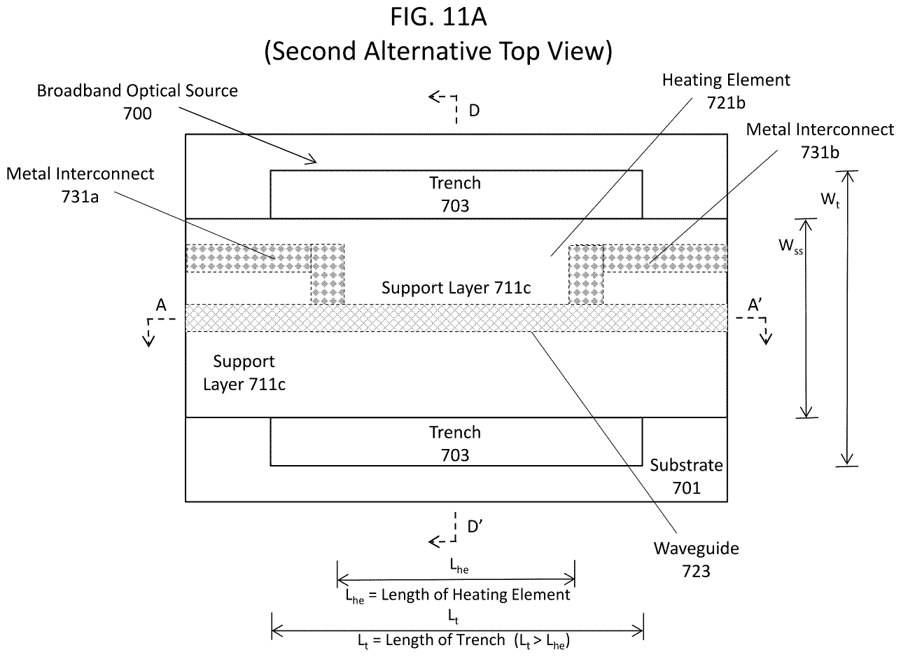

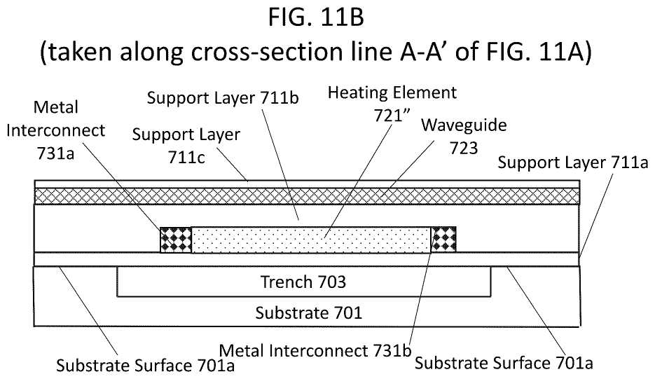

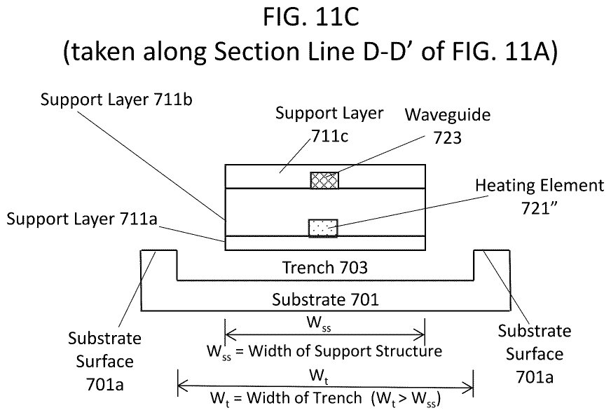

FIGS. 11A, 11B, and 11C illustrate a second alternative to embodiments discussed above with respect to FIGS. 7 and 8A-E. As shown in the cross-sectional views of FIGS. 11B and 11C, a single doped silicon heating element 721″ may be provided between SiN waveguide 723 and trench 703, with support layer 711b separating doped silicon heating element 721″ and SiN waveguide 723.

Examples of embodiments of inventive concepts are provided below.

Embodiment 1. A broadband optical source (700) comprising: a substrate (701) having a surface (701a); a dielectric support layer (711b) on the surface of the substrate, wherein the dielectric support layer (711b) comprises a dielectric material; an electrically conductive heating element (721) on the dielectric support layer (711b); and an optical waveguide (723) on the dielectric support layer (711b), wherein the optical waveguide comprises a waveguide material different than the dielectric material of the dielectric support layer.

Embodiment 2. The broadband optical source according to Embodiment 1, wherein the substrate (701) defines a trench (703) in the surface (701a) thereof, wherein opposite ends of the dielectric support layer (711b) are supported on the surface (701a) of the substrate (701) on opposite ends of the trench (703), wherein a central portion of the dielectric support layer (711b) is suspended across the trench (703) with the trench (703) defining a void between the central portion of the dielectric support layer (711b) and the substrate (701), and wherein each of the electrically conductive heating element (721) and the optical waveguide (723) is on the central portion of the dielectric support layer (711b).

Embodiment 3. The broadband optical source according to Embodiment 2, wherein a length (Lₕₑ) of the heating element (721) is less than a length (Lₜ) of the trench (703).

Embodiment 4. The broadband optical source according to any of Embodiments 2-3, wherein the void defines an air gap and/or a vacuum between the central portion of the dielectric support layer (711b) and the substrate (701).

Embodiment 5. The broadband optical source according to any of Embodiments 1-4 further comprising: first metal interconnect 731a providing electrical coupling between a first end of the heating element (721) and power supply circuitry (1001); and second metal interconnect 731b providing electrical coupling between a second end of the heating element (721) and the power supply circuitry (1001).

Embodiment 6. The broadband optical source according to any of Embodiments 1-5, wherein the electrically conductive heating element (721) comprises first and second electrically conductive heating elements (721a, 721b) on the dielectric support layer (711b), wherein the first and second electrically conductive heating elements (721a, 721b) are spaced apart.

Embodiment 7. The broadband optical source according to any of Embodiments 1-6, wherein the dielectric support layer (711b) is between the waveguide (723) and the heating element (721).

Embodiment 8. The broadband optical source according to any of Embodiments 1-7, wherein the dielectric support layer (711b) is a first dielectric support layer, the photonic integrated circuit device further comprising: a second dielectric support layer (711c) on the first dielectric support layer (711b) and on the optical waveguide (723) so that the optical waveguide (723) is between the first and second dielectric support layers (721b, 721c).

Embodiment 9. The broadband optical source according to Embodiment 8 further comprising: a third dielectric support layer (711a), wherein the electrically conductive heating element (721) is between the first and third dielectric support layers (711b, 711a).

Embodiment 10. The broadband optical source according to any of Embodiments 1-9, wherein the substrate (701) comprises a semiconductor substrate.

Embodiment 11. The broadband optical source according to Embodiment 10, wherein the semiconductor substrate comprises a silicon substrate.

Embodiment 12. The broadband optical source according to any of Embodiments 1-11, wherein the electrically conductive heating element (721) comprises a doped semiconductor material.

Embodiment 13. The broadband optical source according to Embodiment 12, wherein the doped semiconductor material comprises doped silicon.

Embodiment 14. The broadband optical source according to any of Embodiments 1-13, wherein a refractive index of the waveguide material is greater than a refractive index of the dielectric material of the dielectric support layer (711b).

Embodiment 15. The broadband optical source according to any of Embodiments 1-14, wherein the dielectric material of the dielectric support layer (711b) is a first dielectric material, wherein the waveguide material comprises a second dielectric material, and wherein the first and second dielectric materials are different.

Embodiment 16. The broadband optical source according to Embodiment 15, wherein the first dielectric material comprises silicon dioxide (SiO₂) and the second dielectric material comprises silicon nitride (SiN).

Embodiment 17. The broadband optical source according to any of Embodiments 1-16, wherein the electrically conductive heating element (721) is configured to provide broadband optical emission in response to electrical resistive heating, and wherein at least a portion of the broadband optical emission is coupled into the optical waveguide and transmitted through the optical waveguide in a direction parallel the surface (701a) of the substrate (701).

Embodiment 18. The broadband optical source according to Embodiment 17, wherein the optical waveguide (723) is optically coupled with a photonic component (1003) on the substrate (701) so that the portion of the broadband optical emission is coupled through the optical waveguide (723) to the photonic component (1003) on the substrate (701).

Embodiment 19. The broadband optical source according to Embodiment 18, wherein the photonic component (1003) comprises at least one of a waveguide, a delay line, an optical cavity filter, a modulator, a chemical/biological sensor, a photodetector, a photodiode, a spectrometer, and/or a spiral waveguide.

Embodiment 20. The broadband optical source according to Embodiment 18, wherein the photonic component (1003) comprises a spectral filter configured to filter at least a portion of the broadband optical emission coupled through the waveguide (723).

Embodiment 21. The broadband optical source according to Embodiment 20, wherein the spectral filter comprises at least one of a Mach-Zehnder interferometer, a lattice filter, a Fabry-Perot cavity, a microring resonator cavity, a photonic crystal cavity, a directional coupler, and/or an integrated photonic component with a wavelength-dependent response.

Embodiment 22. A photonic integrated circuit (PIC) device, the PIC device comprising: a broadband optical source (700) including, a substrate (701) having a surface (701a), a dielectric support layer (711b) on the surface of the substrate, wherein the dielectric support layer (711b) comprises a dielectric material, an electrically conductive heating element (721) on the dielectric support layer (711b), and an optical waveguide (723) on the dielectric support layer (711b), wherein the optical waveguide comprises a waveguide material different than the dielectric material of the dielectric support layer; power supply circuitry (1001) on the substrate (701), wherein the power supply circuitry (1001) is configured to provide electrical current through the electrically conductive heating element (721) to drive thermal emission of optical output from the electrically conductive heating element (721) due to electrical resistive heating, wherein at least a portion of the optical output is coupled into the waveguide (723); and a photonic component (1003) on the substrate (701), wherein the optical waveguide (723) is optically coupled with the photonic component so that the portion of the broadband optical emission is coupled through the optical waveguide (723) to the photonic component (1003) on the substrate (701).

Embodiment 23. The PIC device according to Embodiment 22, wherein the substrate (701) defines a trench (703) in the surface (701a) thereof, wherein opposite ends of the dielectric support layer (711b) are supported on the surface (701a) of the substrate (701) on opposite ends of the trench (703), wherein a central portion of the dielectric support layer (711b) is suspended across the trench (703) with the trench (703) defining a void between the central portion of the dielectric support layer (711b) and the substrate (701), and wherein each of the electrically conductive heating element (721) and the optical waveguide (723) is on the central portion of the dielectric support layer (711b).

Embodiment 24. An optical source (700) comprising: a substrate (701) having a surface (701a), wherein the substrate defines a trench (703) in the surface (701a) thereof; a dielectric support layer (711b) on the surface of the substrate, wherein the dielectric support layer (711b) comprises a dielectric material, wherein opposite ends of the dielectric support layer (711b) are supported on the surface (701a) of the substrate (701) on opposite ends of the trench (703), wherein a central portion of the dielectric support layer (711b) is suspended across the trench (703) with the trench (703) defining a void between the central portion of the dielectric support layer (711b) and the substrate (701); an optical emission element (721) on the central portion of the dielectric support layer (711b), wherein the void is between the optical emission element and the substrate (701); and an optical waveguide (723) on the central portion of the dielectric support layer (711b), wherein the void is between the optical waveguide and the substrate, and wherein the optical waveguide comprises a waveguide material different than the dielectric material of the dielectric support layer.

Embodiment 25. The optical source according to Embodiment 24, wherein the optical emission element comprises an electrically conductive heating element (721).

Embodiment 26. A photonic integrated circuit (PIC) device, the PIC device comprising: a broadband optical source (700) including, a substrate (701) having a surface (701a), wherein the substrate defines a trench (703) in the surface (701a) thereof, a dielectric support layer (711b) on the surface of the substrate, wherein the dielectric support layer (711b) comprises a dielectric material, wherein opposite ends of the dielectric support layer (711b) are supported on the surface (701a) of the substrate (701) on opposite ends of the trench (703), wherein a central portion of the dielectric support layer (711b) is suspended across the trench (703) with the trench (703) defining a void between the central portion of the dielectric support layer (711b) and the substrate (701), an optical emission element (721) on the central portion of the dielectric support layer (711b), wherein the void is between the optical emission element and the substrate (701), and an optical waveguide (723) on the central portion of the dielectric support layer (711b), wherein the void is between the optical waveguide and the substrate, and wherein the optical waveguide comprises a waveguide material different than the dielectric material of the dielectric support layer; power source circuitry (1001) on the substrate (701), wherein the power source circuitry (1001) is configured to provide electrical current through optical emission element (721) to drive optical output from the optical emission element (721), wherein at least a portion of the optical output is coupled into the waveguide (723); and a photonic component (1003) on the substrate (701), wherein the optical waveguide (723) is optically coupled with the photonic component so that the portion of the optical output is coupled through the optical waveguide (723) to the photonic component (1003) on the substrate (701).

Embodiment 27. The PIC device according to Embodiment 26, wherein the optical emission element comprises an electrically conductive heating element (721).

Optical sources according to some embodiments of inventive concepts and PIC devices including such optical sources may be used to provide PIC component metrology (e.g., on-chip measurement of photonic components) and/or to provide chip-scale chemical sensors. For example, a full chemical sensor system may be provided by incorporating a broadband optical source as disclosed herein with a waveguide based sensor on a single chip using absorption spectroscopy.

Full citations of the references noted herein are provided below, and the disclosures of these references are hereby incorporated herein in their entireties by references.
Reference [1]. FAHRENKOPF, N. M., et al., “The AIM Photonics MPW: A highly accessible cutting edge technology for rapid prototyping of photonic integrated circuits,” IEEE Journal of Selected Topics in Quantum Electronics, Vol. 25, Issue 5, 6 pages, Aug. 20, 2019.
Reference [2]. GIEWONT, K., et al., “300-mm monolithic silicon photonics foundry technology,” IEEE Journal of Selected Topics in Quantum Electronics, Vol. 25, No. 5, 11 pages, Apr. 1, 2019.
Reference [3]. POON, J. K. S., et al., “Silicon photonics for the visible and near-infrared spectrum,” Adv. Opt. Photon., Vol. 16, Issue 1, 59 pages, March 2024.
Reference [4]. SHEKHAR, S., et al, “Roadmapping the next generation of silicon photonics,” Nature Communications, Vol. 15, Article No. 751, 15 pages, Jan. 25, 2024.
Reference [5]. XING, Y., et al., “3d integration enables ultralow-noise isolator-free lasers in silicon photonics,” Nature, Vol. 620, pages 78-85, Aug. 10, 2023.
Reference [6]. SHANG, C., et al., “High-temperature reliable quantum-dot lasers on Si with misfit and threading dislocation filters,” Optica, Vol. 8, No. 5, pages 749-754, May 2021.
Reference [7]. HAN, Y., et al., “Recent advances in light sources on silicon,” Adv. Opt. Photon., Vol. 14, No. 3, pages 404-454, September 2022.
Reference [8]. NITKOWSKI, A., et al., “Cavity-enhanced on-chip absorption spectroscopy using microring resonators,” Opt. Express, Vol. 16, No. 16, pages 11930-11936, Aug. 4, 2008.
Reference [9]. STIEVATER, T. H., et al., “Trace gas absorption spectroscopy using functionalized microring resonators,” Opt. Lett., Vol. 39, No. 4, pages 969-972, Feb. 15, 2014.
Reference [10]. TOMBEZ, L., et al., “Methane absorption spectroscopy on a silicon photonic chip,” Optica, Vol. 4, No . . . 11, pages 1322-1325 Nov. 2017.
Reference [11]. GOLDENSTEIN, C. S., et al., “Infrared laser-absorption sensing for combustion gases,” Progress in Energy and Combustion Science, Vol. 60, pages 132-176, May 2017.
Reference [12]. BAUER, D., et al., “Design and fabrication of a thermal infrared emitter,” Sensors and Actuators A: Physical, Vol. 55, pages 57-63 (1996).
Reference [13]. LIN, S. Y., et al., “Highly efficient light emission at A=1.5 μm by a three-dimensional tungsten photonic crystal,” Opt. Lett., Vol. 28, No. 18, pages 1683-1685 Sep. 15, 2003.
Reference [14]. BARRITAULT, P., et al., “Mid-ir source based on a free-standing microhotplate for autonomous co2 sensing in indoor applications,” Sensors and Actuators A: Physical, Vol. 172, pages 379-385, Oct. 10, 2011.
Reference [15]. INOUE, T., et al., “Realization of narrowband thermal emission with optical nanostructures,” Optica, Vol. 2, No. 1, pages 27-35, January 2015.
Reference [16]. LOCHBAUM, A., et al., “On-chip narrowband thermal emitter for mid-ir optical gas sensing,” ACS Photonics, Vol. 4, No. 6, pages 1371-1380 Apr. 17, 2017.
Reference [17]. BARANOV, D. G., et al., “Nanophotonic engineering of far-field thermal emitters,” Nature Materials, Vol. 18, pages 920-930, September 2019.
Reference [18]. PYATKOV, F., et al., “Sub-nanosecond light-pulse generation with waveguide-coupled carbon nanotube transducers,” Beilstein Journal of Nanotechnology, Vol. 8, pages 38-44, Jan. 5, 2017.
Reference [19]. CONSANI, C., et al., “Mid-infrared photonic gas sensing using a silicon waveguide and an integrated emitter,” Sensors and Actuators B: Chemical 274, pages 60-65, Jul. 26, 2018.
Reference [20]. NEGM, N. et al., “Graphene thermal infrared emitters integrated into silicon photonic waveguides,” ACS Photonics, Vol. 11, pages 2961-2969 Jun. 26, 2024.
Reference [21]. Li, J., et al., “Spectral nearfield thermal emission extraction by optical waveguides,” Phys. Rev. B, Vol. 99, 235414, 8 pages, Jun. 12, 2019.
Reference [22]. PRUESSNER, M. W., et al, “Broadband near-infrared emission in silicon waveguides,” Nature Communications, Vol. 15, Article No. 4639, 8 pages, May 31, 2024.
Reference [23]. FOHRMANN, S., et al, “Single mode thermal emission,” Opt. Express, Vol. 23, Issue 21, pages 27672-27682, Oct. 13, 2015.
Reference [24]. PRUESSNER, M. W., et al., “Enhanced thermo-optic effects in silicon nitride photonic integrated circuits via polymer claddings,” Journal of Nanophotonics, Vol. 17, No. 4, 046001, 10 pages, November 2023.
Reference [25]. ARABI, A., et al, “Measurements of the refractive indices and thermo-optic coefficients of Si3N4 and SiO(x) using microring resonances,” Opt. Lett., Vol. 38, No. 19, pages 3878-3881 Oct. 1, 2013.
Reference [26]. JOHNSON, K., et al, “Determination of the nonlinear thermo-optic coefficient of silicon nitride and oxide using an effective index method,” Opt. Express, Vol. 30, No. 26, pages 46134-46146, Dec. 19, 2022.
Reference [27]. GAO, H., et al., “Investigation on the thermo-optic coefficient of silica fiber within a wide temperature range,” Journal of Lightwave Technology, Vol. 36, No. 24, pages 5881-5886 Dec. 15, 2018.
Reference [28]. COENEN, D., et al., “Thermal Modelling of Silicon Photonic Ring Modulator with Substrate Undercut,” Journal of Lightwave Technology, Vol. 40, No. 13, pages 4357-4363 Jul. 1, 2022.
Reference [29]. HUMBACH, O., et al “Analysis of OH absorption bands in synthetic silica,” Journal of Non-Crystalline Solids, Vol. 203, pages 19-26, Aug. 1, 1996.
Reference [30]. BAUTERS, J. F., et al., “Planar waveguides with less than 0.1 db/m propagation loss fabricated with wafer bonding,” Opt. Express, Vol. 19, No. 24, pages 24090-24101, Nov. 21, 2011.
Reference [31]. TIMANS, P. J., “Emissivity of silicon at elevated temperatures,” Journal of Applied Physics, Vol. 74, No. 10, pages 6353-6364 Nov. 15, 1993.
Reference [32]. STURM, J., et al, “Silicon temperature measurement by infrared absorption. Fundamental processes and doping effects,” IEEE Transactions on Electron Devices, Vol. 39, pages 81-88, January 1992.
Reference [33]. CORATO-ZANARELLA, M., et al., “Absorption and scattering limits of silicon nitride integrated photonics in the visible spectrum,” Optics Express, Vol. 32, No. 4, pages 5718-5728 Feb. 12, 2024).
Reference [34]. GAO, H., et al, “Investigation on the Thermo-Optic Coefficient of Silica Fiber Within a Wide Temperature Range,” Journal of Lightwave Technology, Vol. 36, No. 24, pages 5881-5886 Dec. 15, 2018.
Reference [35]. KAMEDA, A., et al., “Precise measurement of the temperature of a silicon wafer by an optical-interference contactless thermometer during rapid plasma processing,” Journal of Applied Physics, Vol. 127, No. 20, 203302, 10 pages, May 27, 2020.
Reference [36]. JOHNSON, K., et al., “Determination of the nonlinear thermo-optic coefficient of silicon nitride and oxide using an effective index method,” Optics Express, Vol. 30, No. 26, pages 46134-46146, Dec. 19, 2022.
Reference [37]. MARSHALL, J. T., “The development of the manufacture of the Edison incandescent electric lamp-1881-1905,” Journal of the Franklin Institute, Volume 160, Issue 1, Pages 21-49, July 1905.
Reference [38]. PRUESSNER, M. W., et al., “A waveguide thermal emitter,” APL Photon., Vol. 10, pages 036103-1 to 036103-8, Mar. 3, 2025.
Reference [39]. TYNDALL, N. F., et al., “Figure-of-merit characterization of hydrogen-bond acidic sorbents for waveguide-enhanced Raman spectroscopy,” ACS Sensors, Vol. 5, No. 3, pages 831-836, Mar. 10, 2020.
Reference [40]. TYNDALL, N. F., et al., “Mode-crossing spectroscopy for photonic waveguide characterization,” APL Photonics, Vol. 4, pages 106107-1 to 106107-6, Oct. 11, 2019.
Reference [41]. SUGITA, A., et al., “Bridge-suspended silica-waveguide thermo-optic phase shifter and its application to mach-zehnder type optical switch,” IEICE TRANSACTIONS (1976-1990) 73, pages 105-109, January 1990.
Reference [42]. PRUESSNER, M. W., et al., “Photonic Integrated Circuit Devices Including Radiation Emitting Diodes Configured to Emit Radiation Through Semiconductor Waveguides,” U.S. Patent Pub. No. 2025/0081691, published Mar. 6, 2025.
Reference [43]. PRUESSNER, M. W., et al., “A waveguide thermal emitter,” APL Photonics, Vol. 10, 036103, 8 pages, Mar. 3, 2025.
Reference [44]. LIPKOWITZ, S. T., et al., “Broadband Thermal Emission from an Integrated Silicon Waveguide,” in CLEO 2025, Technical Digest Series (Optica Publishing Group), paper SS190-4, 2 pages, May 4-9, 2025.

Additional disclosure is provided below.

The aspects and features of present inventive concepts summarized herein can be embodied in various forms. The description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure. Moreover, the disclosures of all references cited herein are hereby incorporated herein in their entireties by reference.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on”, “connected” to/with, or “coupled” to/with another element, it can be directly on, connected to/with, or coupled to/with the other element, or intervening elements may be present. In contrast, when an element is referred to as being “directly on”, “directly connected” to/with, or “directly coupled” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region/element illustrated as having right angle features, typically, have rounded or curved features at its edges/corners. Thus, the regions illustrated in the figures are schematic in nature and their shapes are not intended to illustrate the actual shape of a region of a device and are not intended to limit the scope of the present inventive concepts. Moreover, the sizes/thicknesses of elements/layers may be exaggerated for clarity and convenience of explanation.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

Unless otherwise defined, all terms (including technical and scientific terms) used herein have the same meaning as commonly understood by one of ordinary skill in the art to which inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. A optical source comprising:
a substrate having a surface;
a dielectric support layer on the surface of the substrate, wherein the dielectric support layer comprises a dielectric material;
an electrically conductive heating element on the dielectric support layer; and
an optical waveguide on the dielectric support layer, wherein the optical waveguide comprises a waveguide material different than the dielectric material of the dielectric support layer.

2. The optical source according to claim 1, wherein the substrate defines a trench in the surface thereof, wherein opposite ends of the dielectric support layer are supported on the surface of the substrate on opposite ends of the trench, wherein a central portion of the dielectric support layer is suspended across the trench with the trench defining a void between the central portion of the dielectric support layer and the substrate, and wherein each of the electrically conductive heating element and the optical waveguide is on the central portion of the dielectric support layer.

3. The optical source according to claim 2, wherein a length of the heating element is less than a length of the trench.

4. The optical source according to claim 2, wherein the void defines an air gap and/or a vacuum between the central portion of the dielectric support layer and the substrate.

5. The optical source according to claim 1 further comprising:
first metal interconnect providing electrical coupling between a first end of the heating element and power supply circuitry; and
second metal interconnect providing electrical coupling between a second end of the heating element and the power supply circuitry.

6. The optical source according to claim 1, wherein the electrically conductive heating element comprises first and second electrically conductive heating elements on the dielectric support layer, wherein the first and second electrically conductive heating elements are spaced apart.

7. The optical source according to claim 1, wherein the dielectric support layer is between the waveguide and the heating element.

8. The optical source according to claim 1, wherein the dielectric support layer is a first dielectric support layer, the photonic integrated circuit device further comprising:
a second dielectric support layer on the first dielectric support layer and on the optical waveguide so that the optical waveguide is between the first and second dielectric support layers.

9. The optical source according to claim 1, wherein a refractive index of the waveguide material is greater than a refractive index of the dielectric material of the dielectric support layer.

10. The optical source according to claim 1, wherein the dielectric material of the dielectric support layer is a first dielectric material, wherein the waveguide material comprises a second dielectric material, and wherein the first and second dielectric materials are different.

11. The optical source according to claim 1, wherein the electrically conductive heating element is configured to provide optical emission in response to electrical resistive heating, and wherein at least a portion of the optical emission is coupled into the optical waveguide and transmitted through the optical waveguide in a direction parallel the surface of the substrate.

12. The optical source according to claim 11, wherein the optical waveguide is optically coupled with a photonic component on the substrate so that the portion of the optical emission is coupled through the optical waveguide to the photonic component on the substrate.

13. The optical source according to claim 12, wherein the photonic component comprises at least one of a waveguide, a delay line, an optical cavity filter, a modulator, a chemical/biological sensor, a photodetector, a photodiode, a spectrometer, and/or a spiral waveguide.

14. The optical source according to claim 12, wherein the photonic component comprises a spectral filter configured to filter at least a portion of the optical emission coupled through the waveguide.

15. A photonic integrated circuit (PIC) device, the PIC device comprising:
a optical source including,
a substrate having a surface,
a dielectric support layer on the surface of the substrate, wherein the dielectric support layer comprises a dielectric material,
an electrically conductive heating element on the dielectric support layer, and an optical waveguide on the dielectric support layer, wherein the optical waveguide comprises a waveguide material different than the dielectric material of the dielectric support layer;
power supply circuitry on the substrate, wherein the power supply circuitry is configured to provide electrical current through the electrically conductive heating element to drive thermal emission of optical output from the electrically conductive heating element due to electrical resistive heating, wherein at least a portion of the optical output is coupled into the waveguide; and
a photonic component on the substrate, wherein the optical waveguide is optically coupled with the photonic component so that the portion of the optical emission is coupled through the optical waveguide to the photonic component on the substrate.

16. The PIC device according to claim 15, wherein the substrate defines a trench in the surface thereof, wherein opposite ends of the dielectric support layer are supported on the surface of the substrate on opposite ends of the trench, wherein a central portion of the dielectric support layer is suspended across the trench with the trench defining a void between the central portion of the dielectric support layer and the substrate, and wherein each of the electrically conductive heating element and the optical waveguide is on the central portion of the dielectric support layer.

17. An optical source comprising:
a substrate having a surface, wherein the substrate defines a trench in the surface thereof;
a dielectric support layer on the surface of the substrate, wherein the dielectric support layer comprises a dielectric material, wherein opposite ends of the dielectric support layer are supported on the surface of the substrate on opposite ends of the trench, wherein a central portion of the dielectric support layer is suspended across the trench with the trench defining a void between the central portion of the dielectric support layer and the substrate;
an optical emission element on the central portion of the dielectric support layer, wherein the void is between the optical emission element and the substrate; and
an optical waveguide on the central portion of the dielectric support layer, wherein the void is between the optical waveguide and the substrate, and wherein the optical waveguide comprises a waveguide material different than the dielectric material of the dielectric support layer.

18. The optical source according to claim 17, wherein the optical emission element comprises an electrically conductive heating element.

19. A photonic integrated circuit (PIC) device, the PIC device comprising:
a optical source including,
a substrate having a surface, wherein the substrate defines a trench in the surface thereof,
a dielectric support layer on the surface of the substrate, wherein the dielectric support layer comprises a dielectric material, wherein opposite ends of the dielectric support layer are supported on the surface of the substrate on opposite ends of the trench, wherein a central portion of the dielectric support layer is suspended across the trench (703) with the trench (703) defining a void between the central portion of the dielectric support layer (711b) and the substrate (701),
an optical emission element on the central portion of the dielectric support layer, wherein the void is between the optical emission element and the substrate, and an optical waveguide on the central portion of the dielectric support layer,
wherein the void is between the optical waveguide and the substrate, and wherein the optical waveguide comprises a waveguide material different than the dielectric material of the dielectric support layer;
power source circuitry on the substrate, wherein the power source circuitry is configured to provide electrical current through optical emission element to drive optical output from the optical emission element, wherein at least a portion of the optical output is coupled into the waveguide; and
a photonic component on the substrate, wherein the optical waveguide is optically coupled with the photonic component so that the portion of the optical output is coupled through the optical waveguide to the photonic component on the substrate.

20. The PIC device according to claim 19, wherein the optical emission element comprises an electrically conductive heating element.
